(19) United States
(12) Patent Application Publication
(10) Pub. No.: US 2019/0152854 A1
(43) Pub. Date: May 23, 2019

(54) GEOPOLYMER FOAM FORMULATION

(71) Applicant: CONSTRUCTION RESEARCH & TECHNOLOGY GMBH, Trostberg (DE)

(72) Inventors: Maik SCHLESINGER, Ludwigshafen (DE); Bernhard FEICHTENSCHLAGER, Trostberg (DE); Sarunas TURCINSKAS, Trostberg (DE)

(73) Assignee: Construction Research & Technology GmbH, Trostberg (DE)

(21) Appl. No.: 16/091,237

(22) PCT Filed: Apr. 4, 2017
(86) PCT No.: PCT/EP2017/057950

§ 371 Date: Oct. 4, 2018

(30) Foreign Application Priority Data
Apr. 7, 2016 (EP) 16164263.2

(51) Int. Cl. C04B 28/00; C04B 24/38; C04B 38/10

(52) U.S. Cl. CPC C04B 28/008; C04B 24/38; C04B 2103/40; C04B 38/103; C04B 24/383

(57) ABSTRACT

A method for producing a geopolymer foam is proposed, comprising providing a foamable formulation, foaming the formulation, and allowing the foamed formulation to harden. The foamable formulation comprises at least one inorganic binder selected from the group consisting of latent hydraulic binders, pozzolanic binders and mixtures thereof; at least one alkaline activator selected from the group consisting of alkali metal hydroxides, alkali metal carbonates, alkali metal aluminates, alkali metal silicates and mixtures thereof; at least one surfactant; nanocellulose and water. The mechanical properties of the foam are improved by incorporating nanocellulose.

The present invention relates to a method for producing a geopolymer foam, the geopolymer foam obtainable by the method, a foamable formulation for the manufacture of a geopolymer foam, and the use of said geopolymer foam for the production of a flame-resistant, sound-absorbing, thermally insulating geopolymer foam element.

Room acoustics depend greatly on architectural parameters. The variables that determine room acoustics can be influenced to a greater or lesser extent via appropriate room design. An important objective in room acoustics, alongside simple noise reduction, is to adapt the acoustic properties of a room to its intended purpose. Acoustic fields in rooms are diffuse, unlike those in the external world, because they are generated by direct and reflected sound. They can be controlled via appropriate acoustic power reduction. Technical sound absorbers are used here which permit targeted absorption and reflection.

In principle, it is possible to divide technical absorbers into two groups based on their mode of operation, namely into resonators and porous absorbers. The mode of operation of resonators very generally involves acoustic spring-mass systems which have a pronounced sound absorption maximum. Examples of these sound absorbers are sheet resonators, Helmholtz resonators and microperforated absorbers.

In contrast to this, porous absorbers primarily absorb acoustic energy via friction at the pore walls, where it is converted into thermal energy. This requires an open-pore structure with adequate porosity. Because sound absorption is achieved primarily via dissipation, the sound absorption spectrum of porous sound absorbers is significantly different from that of resonators. In the case of resonators, the frequency-dependent sound absorption coefficient ideally rises constantly towards higher frequencies in the shape of an s and asymptotically approaches a maximum. Porous absorbers can have various structures. Many different materials can be used here.

Foam products are generally two-phase systems, where one phase is gaseous and the other is solid or liquid. The gaseous phase here consists of fine gas bubbles delimited by solid or liquid cell walls. The cell walls meet one another at nodes and thus form a framework.

Foams with sound-absorbing properties are mostly open-cell foams. The thin partitions between the delimiting walls here are disrupted at least to some extent, and there is at least some connection between the cells. The material thus acts as porous absorber. Very many different materials are used for the cell walls in open-cell foams. They range from metals to inorganic materials and to organopolymers, which nowadays make up by far the greatest proportion in industrial use, the term foams being generally applied to these. Organopolymer foams are divided, on the basis of their rigidity, into flexible and rigid foams. Formation of bubbles in these is mostly achieved by way of a blowing gas which is produced in situ via a chemical reaction, or by way of a chemical compound which is dissolved in the organic matrix and which, at low temperatures, boils or decomposes to give gaseous products. Foams can also be produced via mechanical mixing to incorporate gases, via polymerization in solution with phase separation, or via use of fillers which are dissolved out from the material after the curing process.

In the literature there are many descriptions of open-cell PUR foams. They are usually produced from isocyanate-containing compounds and polyols. Foaming predominantly uses blowing gases which have physical action by virtue of their low boiling point. There are also specific well-known blowing gas combinations of blowing gases having physical action and carbon dioxide produced via chemical reaction of the isocyanate groups with water during the foaming process. During reaction of water with isocyanates, unlike in the reaction of polyols, urea groups are produced alongside carbon dioxide, and contribute to the formation of the cell structure. Melamine foams provide another alternative.

A decisive disadvantage of organopolymer foams is that they are combustible, or, to use a different expression, have restricted thermal stability. Even organopolymer foams classified as having “low flammability” can, on combustion, liberate toxic gases and produce flaming drops. They can also, if they have been produced in particular ways and have particular compositions, liberate fumes that are hazardous in indoor areas, an example being formaldehyde. There was therefore a requirement for incombustible inorganic foams.

DE 102004006563 A1 describes a process for the production of an inorganic-organic hybrid foam by the following steps: a) mixing of at least one inorganic reactive component that forms a stone-like material, at least one aqueous hardener which, under alkaline conditions, brings about a curing reaction of the at least one inorganic reactive component, at least one foaming agent, at least one organic silicon compound and at least one surfactant, and b) at least partial hardening of the mixture. However, no purely inorganic foam is formed here.

DE 4301749 A1 describes an acoustic damper for the passage of exhaust gases from internal combustion engines with at least one sound-absorbing body made of a porous material. In order to achieve the best possible acoustic damping together with simple production, it is proposed that the material is based on a geopolymer. However, the composition of the geopolymer here is not explained in any greater detail.

WO 2011/106815 A1 describes a formulation for the production of a fire-protection mineral foam comprising or consisting of a water glass, at least one aluminium silicate, at least one hydroxide and at least one oxidic component from a group comprising SiO₂ and Al₂O₃, characterized in that the water glass is present in a proportion selected from a range of 10 parts by weight and 50 parts by weight, the aluminium silicate is present in a proportion such that the proportion of Al₂O₃ is from 8 parts by weight to 55 parts by weight, the hydroxide is present in a proportion such that the proportion of OH is from 0.5 part by weight to 4 parts by weight, and the oxidic component is present in a proportion of from 5 parts by weight to 55 parts by weight; it also describes the mineral foam and a process for the production of the mineral foam.

That document proposes as preferred aluminium silicate an aluminium silicate activatable under alkaline conditions, in particular a volcanic aluminium silicate, preferably basalt, pitchstone, obsidian, phonolite, and/or metakaolin; SiO₂ and, respectively, Al₂O₃ is proposed as preferred oxidic component. Although WO 2011/106815 A1 provides no inventive examples, it was found that use of these components could achieve only inadequate early and final strength values for the hardened geopolymer foam. There was therefore a requirement for incombustible inorganic foams with adequate early and final strength.

U.S. Pat. No. 8,273,174 (and U.S. Pat. No. 8,293,003) discloses a fiber cement board comprising a cementitious matrix, kraft cellulose pulp fibers and nanocrystalline cellulose both dispersed throughout said matrix. The cement board has a better modulus of elasticity without sacrificing flexural strength and energy to break.

WO 2013/126321 discloses a joint compound comprising nanocrystalline cellulose, water, a filler, a latex as a binder and a thickener. The nanocrystalline cellulose is used in an amount which is effective to improve crack resistance of the joint compound upon drying.

US 2013/0000523 discloses a cured cementitious structure comprising cement and fibrillated nano or micro celluloses carboxyalkyl cellulose, cellulose alkylsulfonic acid, phosphorylated cellulose or sulphated cellulose.

WO 2011/039423 discloses a cement admixture comprising microfibrillar cellulose and/or a derivative thereof and/or a labile chemically modified cellulose pulp or cellulose raw material which forms microfibrillar cellulose during the use of the admixture. The admixture is said to solve the problems of segregation and bleeding in concrete formulations.

WO 2015/062860 discloses a geopolymer foam formulation for a non-flammable, sound-absorbing, thermally insulating geopolymer foam element. The formulation comprises least one inorganic binder selected from the group consisting of latently hydraulic binders, pozzolanic binders and mixtures thereof; at least one alkaline activator; at least one surfactant; a gas phase and water. The geopolymer foam formulation is, for example, useful for producing reinforced concrete elements comprising the foam as sound absorber, as disclosed in WO 2015/063022.

WO 2014/183082 discloses a cement paste composition comprising cement, water and cellulose nanocrystals (CNC). The composition can be hardened to a cement composition having increased flexural strength. Isothermal calorimetry and thermogravimetric analysis show that the degree of hydration (DOH) of the cement paste is increased when CNCs are used. Increasing the DOH increases the flexural strength of a resulting cured cement paste. Whereas the hardening of a cement composition, such as Portland cement (PC), occurs through simple hydration of calcium silicate into calcium disilicate hydrate and lime Ca(OH)₂, the setting of a geopolymer composition involves poly-condensation of oligo-(sialate-siloxo) moieties into a poly(sialate-siloxo) cross-linked network, generally initiated by an alkaline solution. Due to the different hardening mechanism, the known use of CNC in cement pastes has no bearing to the use of CNC in geopolymer formulations. Further, in discussing the prior art described in U.S. Pat. No. 8,293,003 (Thomson et al.). WO 2014/183082 discourages the use of surfactants by stating “added surfactant is likely deleterious to strength”.

In the mineral foams as disclosed in the prior art shrinkage during drying and hardening is a challenging problem due to the formation of microcracks which give rise to an impaired performance with regard to the mechanical, sound-absorbing and insulating properties.

The problem underlying the invention was therefore to provide a method for producing a flame-resistant geopolymer foam having improved mechanical, sound-absorbing, thermally insulating properties. As to the mechanical properties, the foam should have adequate early and final strength, so as to ensure good practical handling properties.

This problem has been solved by a method producing a geopolymer foam, comprising

(i) providing a foamable formulation comprising
a) at least one inorganic binder selected from the group consisting of latently hydraulic binders, pozzolanic binders and mixtures thereof;
b) at least one alkaline activator selected from the group consisting of alkali metal hydroxides, alkali metal carbonates, alkali metal aluminates, alkali metal silicates and mixtures thereof;
c) at least one surfactant selected from the group consisting of anionic surfactants, cationic surfactants, non-ionic surfactants and mixtures thereof; and
d) 0.1 to 5 wt.-%, based on the weight of the formulation, of nanocellulose, and
e) water;
   (ii) foaming the formulation; and
   (iii) allowing the foamed formulation to harden.

In a further aspect, the invention relates to the foamable formulation described above.

In still a further aspect, the invention relates to a dry formulation adapted for reconstituting with water to form a foamable formulation as described above.

In still a further aspect, the invention relates to the geopolymer foam obtainable by the above method.

The geopolymer foam comprises regions of a gas separated by a solid film of a geopolymer, the geopolymer having nanocellulose dispersed therein. The geopolymer is the polycondensation product of at least one inorganic binder as defined herein, induced by at least one alkaline activator as defined herein. Preferably, the nanocellulose is present in an amount of 0.15 to 8.5 wt.-%, in particular 0.85 to 5.0 wt.-%, based on the geopolymer solids.

For the purposes of the present invention, the term “comprising” is intended to include the term “consisting of”, but not to be synonymous therewith. It is moreover intended that in each actual case the sum of all of the percentages of the specified and unspecified constituents of the formulation of the invention is always 100%. Thus, all percentages are based on the total weight of the formulation.

It is well known that inorganic binder systems can be based on reactive water-insoluble compounds based on SiO₂ in conjunction with Al₂O₃ which harden in an aqueous alkaline environment. Binder systems of this type are termed inter alia “geopolymers”, and are described by way of example in U.S. Pat. No. 4,349,386, WO 85/03699 and U.S. Pat. No. 4,472,199. Materials that can be used as reactive oxide or reactive oxide mixture here are inter alia microsilica, metakaolin, aluminosilicates, fly ash, activated clay, pozzolans or a mixture thereof. The alkaline environment used to activate the binders usually comprises aqueous solutions of alkali metal carbonates, alkali metal fluorides, alkali metal hydroxides, alkali metal aluminates and/or alkali metal silicates, e.g. soluble water glass. Geopolymers can be less costly and more robust than Portland cement and can have a more advantageous CO₂ emission balance.

Pure geopolymers generally have a low calcium content because they use the abovementioned oxides. U.S. Pat. No. 8,460,459 B2 describes an inorganic binder system which comprises from 12 to 25% by weight of CaO, and which permits production of construction chemical products that are resistant to chemical attack. (However, that document does not indicate any geopolymer foam formulation and does not provide a geopolymer foam element or give any consideration thereto).

For the purposes of the present invention, a “latent hydraulic binder” is preferably a binder in which the molar ratio (CaO+MgO):SiO₂ is from 0.8 to 2.5 and particularly from 1.0 to 2.0. In general terms, the above-mentioned latent hydraulic binders can be selected from industrial and/or synthetic slag, in particular from blast furnace slag, electrothermal phosphorous slag, steel slag and mixtures thereof, and the “pozzolanic binders” can generally be selected from amorphous silica, preferably precipitated silica, fumed silica and microsilica, ground glass, metakaolin, aluminosilicates, fly ash, preferably brown-coal fly ash and hard-coal fly ash, natural pozzolans, such as tuff, trass and volcanic ash, natural and synthetic zeolites and mixtures thereof.

The slag can be either industrial slag, i.e. waste products from industrial processes, or else synthetic slag. The latter can be advantageous because industrial slag is not always available in consistent quantity and quality.

Blast furnace slag (BFS) is a waste product of the glass furnace process. Other materials are granulated blast furnace slag (GBFS) and ground granulated blast furnace slag (GGBFS), which is granulated blast furnace slag that has been finely pulverized. Ground granulated blast furnace slag varies in terms of grinding fineness and grain size distribution, which depend on origin and treatment method, and grinding fineness influences reactivity here. The Blaine value is used as parameter for grinding fineness, and typically has an order of magnitude of from 200 to 1000 m² kg⁻¹, preferably from 300 to 500 m² kg⁻¹. Finer milling gives higher reactivity.

For the purposes of the present invention, the expression “blast furnace slag” is however intended to comprise materials resulting from all of the levels of treatment, milling, and quality mentioned (i.e. BFS, GBFS and GGBFS). Blast furnace slag generally comprises from 30 to 45% by weight of CaO, about 4 to 17% by weight of MgO, about 30 to 45% by weight of SiO₂ and about 5 to 15% by weight of Al₂O₃, typically about 40% by weight of CaO, about 10% by weight of MgO, about 35% by weight of SiO₂ and about 12% by weight of Al₂O₃.

Electrothermal phosphorous slag is a waste product of electrothermal phosphorous production. It is less reactive than blast furnace slag and comprises about 45 to 50% by weight of CaO, about 0.5 to 3% by weight of MgO, about 38 to 43% by weight of SiO₂, about 2 to 5% by weight of Al₂O₃ and about 0.2 to 3% by weight of Fe₂O₃, and also fluoride and phosphate. Steel slag is a waste product of various steel production processes with greatly varying composition.

Amorphous silica is preferably an X-ray-amorphous silica, i.e. a silica for which the powder diffraction method reveals no crystallinity. The content of SiO₂ in the amorphous silica of the invention is advantageously at least 80% by weight, preferably at least 90% by weight. Precipitated silica is obtained on an industrial scale by way of precipitating processes starting from water glass. Precipitated silica from some production processes is also called silica gel.

Fumed silica is produced via reaction of chlorosilanes, for example silicon tetrachloride, in a hydrogen/oxygen flame. Fumed silica is an amorphous SiO₂ powder of particle diameter from 5 to 50 nm with specific surface area of from 50 to 600 m² g⁻¹.

Microsilica is a by-product of silicon production or ferrosilicon production, and likewise consists mostly of amorphous SiO₂ powder. The particles have diameters of the order of magnitude of 0.1 μm. Specific surface area is of the order of magnitude of from 15 to 30 m² g⁻¹.

In contrast to this, commercially available quartz sand is crystalline and has comparatively large particles and comparatively small specific surface area. It serves as inert filler in the invention.

Fly ash is produced inter alia during the combustion of coal in power stations. Class C fly ash (brown-coal fly ash) comprises according to WO 08/012438 about 10% by weight of CaO, whereas class F fly ash (hard-coal fly ash) comprises less than 8% by weight, preferably less than 4% by weight, and typically about 2% by weight of CaO.

Metakaolin is produced when kaolin is dehydrated. Whereas at from 100 to 200° C. kaolin releases physically bound water, at from 500 to 800° C. a dehydroxylation takes place, with collapse of the lattice structure and formation of metakaolin (Al₂Si₂O₇). Accordingly, pure metakaolin comprises about 54% by weight of SiO₂ and about 46% by weight of Al₂O₃.

For the purposes of the present invention, aluminosilicates are the abovementioned reactive compounds based on SiO₂ in conjunction with Al₂O₃ which harden in an aqueous alkali environment. It is of course not essential here that silicon and aluminium are present in oxidic form, as is the case by way of example in Al₂Si₂O₇. However, for the purposes of quantitative chemical analysis of aluminosilicates it is usual to state the proportions of silicon and aluminium in oxidic form (i.e. as “SiO₂” and “Al₂O₃”).

An overview of suitable raw materials for geopolymers is found by way of example in Caijun Shi, Pavel V. Krivenko, Della Roy, Alkali-Activated Cements and Concretes, Taylor & Francis, London & New York, 2006, pp. 6-63.

Particularly suitable materials for the foamable formulation of the invention have however proved to be inorganic binders from the group consisting of blast furnace slag, microsilica, metakaolin, aluminosilicates, fly ash and mixtures thereof. Whereas metakaolin brings about particularly good foaming results, blast furnace slag, in particular in combination with microsilica, is advantageous in providing high early and final strength values of the geopolymer foam obtainable.

In one embodiment of the formulation of the invention, the inorganic binder comprises metakaolin. In another embodiment of the formulation of the invention, the inorganic binder comprises blast furnace slag.

In a preferred embodiment of the present invention, the inorganic binder comprises metakaolin and/or microsilica in addition to blast furnace slag. The basis of one particularly preferred embodiment of the present invention is that the inorganic binder comprises microsilica and metakaolin in addition to blast furnace slag.

It is preferable to select an alkaline activator from alkali metal hydroxides of the formula MOH and alkali metal silicates of the formula m SiO₂.nM₂O, where M is the alkali metal, preferably Li, Na or K or a mixture thereof, and the molar ratio m:n is ≤4.0, preferably ≤3.0, with further preference ≤2.0, in particular ≤1.70, and with very particular preference ≤1.20.

The alkali metal silicate is preferably water glass, particularly preferably an aqueous water glass and in particular a sodium water glass or potassium water glass. However, it is also possible to use lithium water glass or ammonium water glass or a mixture of the water glasses mentioned. The m:n ratio stated above (also termed “modulus”) should preferably not be exceeded, since otherwise reaction of the components is likely to be incomplete. It is also possible to use very much smaller moduli, for example about 0.2. Water glasses with higher moduli should be adjusted before use to moduli in the range of the invention by using a suitable aqueous alkali metal hydroxide.

Potassium water glasses in the advantageous modulus range are mainly marketed as aqueous solutions because they are very hygroscopic; sodium water glasses in the advantageous modulus range are also obtainable commercially as solids. The solids contents of the aqueous water glass solutions are generally from 20% by weight to 60% by weight, preferably from 30 to 50% by weight.

Water glasses can be produced industrially via melting of quartz sand with the appropriate alkali metal carbonates. However, they can also be obtained without difficulty from mixtures of reactive silicas with the appropriate aqueous alkali metal hydroxides. It is therefore possible in the invention to replace at least some of the alkali metal silicate with a mixture of a reactive silica and of the appropriate alkali metal hydroxide.

In one preferred embodiment of the present invention, the alkaline activator therefore comprises a mixture of alkali metal hydroxides and of alkali metal silicates.

The preferred quantity present of the alkaline activator in the invention, based on the foamable formulation, is from 1 to 55% by weight and in particular from 20 to 50% by weight, where these data relate to solids contents of the alkaline activator.

A surfactant is required to render the formulation foamable. In the presence of surfactant and water it is possible to obtain a geopolymer foam by stabilizing a gas phase which is present in the foamed formulation in the form of gas bubbles.

Not all surfactants are equally effective in the highly alkaline geopolymer foam formulation often comprising water glass and latent hydraulic, and/or pozzolanic binders. It has been found that non-ionic surfactants, preferably alkyl polyglucosides, have the best suitability for stabilizing the gas phase and therefore the foam.

Alkyl polyglucosides generally have the formula H—(C₆H₁₀O₅)ₘ—O—R¹, where (C₆H₁₀O₅) is a glucose unit and R¹ is a C₆₋₂₂alkyl group, preferably a C₈₋₁₆-alkyl group and in particular a C₈₋₁₂-alkyl group, and m=from 1 to 5.

Some of the surfactants, preferably less than 30% by weight, can be replaced with saponified balsamic and tall resins. By way of example it is possible here to use Vinapor® MTZ/K50 from BASF SE, which is a pulverulent, spray-dried modified and saponified balsamic and tall resin which is usually used to form air-filled pores.

The proportion of the surfactant, based on the foamable formulation of the invention, can advantageously be from 0.1 to 2.5% by weight and in particular from 0.5 to 1.5% by weight, based on the total solids weight of the formulation.

Nanocellulose is a product that can be obtained from any cellulose sources, such as trees and other plants, algae, bacteria, tunicates. The nanocelluloses may differ from each other depending on the cellulose material used and the extraction method. The term “nanocellulose” as used herein includes all cellulose nanomaterials that have at least one dimension in the nanoscale. Cellulose nanomaterials and their preparation are described, for example, in Chem. Soc. Rev., 2011, 40, 3941-3994; Chem. Rev. 2010, 110, 3479-3500 and WO 2014/183082 which are incorporated herein in their entirety. Nanocellulose is to be distinguished over celluloses due to its crystallinity and the dimensions. Cellulose fibers do not have a dimension in the nanoscale. Their length is generally >500 μm. Nanocellulose is formed of particles having the dimensions given below.

Preferably, the nanocellulose as used herein has a length in the range from about 25 to about 4000 nm, preferably about 50 to about 1000 nm and in particular about 70 to about 500 nm and a width in the range from about 2 to about 70 nm, preferably about 3 to about 60 nm and in particular about 3 to about 50 nm. In an embodiment, the nanocellulose has a crystallinity in the range of about 40 to about 90%, preferably about 50 to about 90%. Suitable nanocelluloses are:

Cellulose nanocrystals (CNC) (sometimes also called nanowhiskers) are rod-like particles having in general a length of about 50 nm to about 500 nm, preferably about 80 nm to about 300 nm and a width of about 3 nm to about 50 nm, preferably about 4 to about 40 nm and in case they have a square or rectangular cross-section a height of about 2 to about 30 nm. Their crystallinity is about 50 to about 90%, preferably about 60 to about 90%. CNCs can be obtained from cellulose by treatment with an acid, such as sulfuric acid. They are commercially available, for example, from the University of Maine, The Process Development Center, 5737 Jenness Hall, Orono, Me. 04469 or from the Cellulose Research Institute, SUNY-ESF, 307 Stadium Place, Syracuse, N.Y.

Cellulose nanofibrils (nanofibrillated cellulose) which are cellulose fibrils having a length of about 500 nm to about 2000 nm and a width of about 4 nm to about 20 nm. They can be prepared as disclosed in Chem. Soc. Rev., 2011, 40, 3941-3994 and are commercially available e.g. from The Process Development Center of The University of Maine or elsewhere.

Tunicate cellulose nanocrystals which are particles produced by acid hydrolysis of tunicates, see Chem. Soc. Rev., 2011, 40, 3941-3994. They have a ribbon-like shape with a height of about 8 nm, a length of about 100 nm to about 4000 nm and a width of about 20 to about 30 nm.

The nanocellulose is contained in the foamable formulation of the invention in an amount of 0.1 to 5 wt.-%, preferably 0.5 to 3 wt.-%.

The foamable formulation is moreover characterized in that it advantageously comprises from 20 to 60% by weight, preferably from 25 to 50% by weight, of water.

Expressed in other terms, the ratio by weight of water to binder (w/b value), where the solids content of the alkaline activator must be counted with the binder and the water content of the alkaline activator must be counted with the water, is from 0.25 to 1.5, in particular from 0.33 to 1.0. Whereas an advantageous w/z value in cementitious systems is from 0.4 to 0.6, the w/b value here is on the somewhat higher side. This has the advantage that the surfactant can sometimes stabilize the gas phase more easily in the systems with higher water content.

The entire foamable formulation of the invention can therefore comprise, based on the weight of the formulation,

from 15 to 70% by weight of inorganic binder,
from 1 to 55% by weight of alkaline activator (calculated as solids content),
from 20 to 60% by weight of water (entire quantity),
from 0.1 to 5% by weight of nanocellulose,
and also surfactant, and optionally other additives.

In one preferred embodiment, the foamable formulation of the invention can comprise, based on the weight of the formulation,

from 15 to 40% by weight of inorganic binder,
from 20 to 50% by weight of alkaline activator (calculated as solids content),
from 20 to 40% by weight of water (entire quantity),
from 0.5 to 3% by weight of nanocellulose,
and also surfactant, and optionally other additives.

A ratio of silicium atoms to aluminium atoms that has proved advantageous in the formulation of the invention is from 10:1 to 1:1, and a preferred ratio here is from 6:1 to 1.5:1 and in particular from 1.8:1 to 2.2:1 and from 4.7:1 to 5.3:1.

The solidification behaviour or the setting time of the foamed formulation of the invention can be influenced advantageously by adding cement. A particularly suitable material here is Portland cement, calcium aluminate cement or a mixture thereof. Particular preference is given here to calcium aluminate cement (in particular with pale colour). It is also possible to use composite cements in categories CEM II-V and CEM X.

Portland cement comprises about 70% by weight of CaO+MgO, about 20% by weight of SiO₂ and about 10% by weight of Al₂O₃+Fe₂O₃. Calcium aluminate cement comprises about 20 to 40% by weight of CaO, up to about 5% by weight of SiO₂, about 40 to 80% by weight of Al₂O₃ and up to about 20% by weight of Fe₂O₃. These cements are well known in the prior art (cf. DIN EN 197).

It is preferable that the proportion of the cement in the foamable formulation is at least 1% by weight, preferably at least 2% by weight and in particular at least 3% by weight. The setting time can also be controlled by adding Ca(OH)₂. The proportion of Ca(OH)₂, based on the foamable formulation of the invention, can be from 1 to 15% by weight, in particular from 3 to 10% by weight. The proportion of cement in the formulation of the invention should be at most 20% by weight, preferably at most 10% by weight and in particular at most 5% by weight. As mentioned above, the sum of all of the percentages of the specified and unspecified constituents of the formulation of the invention here must always be 100%.

Many other additives can be present in the foamable formulation of the invention. The formulation can also comprise at least one additive for foam stabilization, shrinkage reduction, flexibilization, hydrophobization, or dispersion, fibres (having a length of a 500 μm) and fillers or a mixture thereof.

For foam stabilization it is possible to use additives from the group consisting of fumed silica, proteins, rheology-modifying agents, e.g. starches (inter alia xanthan gum), modified starches, poly(meth)acrylates and -(meth)acrylamides bearing sulfo and/or quaternized ammonium groups and mixtures thereof.

Poly(meth)acrylates and -acrylamides bearing sulfo groups and/or bearing quaternized ammonium groups are described by way of example in WO 2008/151878 A1, WO 2007/017286 A1, WO 2005/090424 A1 and WO 02/10229 A1. (Co)polymers of this type are also termed superabsorbing polymers (SAPs) or salt-insensitive superabsorbing polymers (SISAs). Materials involved here are generally rheology-modifying agents and, respectively, thickeners. SISAs are very particularly suitable as thickeners here, specifically because of the high alkalinity, and the attendant high salt loading, of the foamable formulations under consideration here.

Surprisingly, it has been found that the processability of the foam can be improved by adding superabsorbers. Addition of salt-insensitive superabsorbing polymers can markedly increase stiffness and avoid any tendency towards increasing flowability of the silicate foams.

For shrinkage reduction it is possible to use additives from the group consisting of amines, lactams, alkanolamines, betaine(s), glycols, polyols, hollow aluminosilicate beads, hollow glass beads, foamed glass and mixtures thereof. In this context hollow aluminosilicate beads can be considered not only as an additive for shrinkage reduction but also as a pozzolanic binder. Preference is given to hollow aluminosilicate beads with a grain size of at most 100 μm. The proportion of hollow microbeads in the foamable formulation of the invention is preferably at most 30% by weight.

For flexibilization it is possible to use additives from the group consisting of redispersible polymer powders, polyisocyanates, polyisocyanate prepolymers, epoxy resins, epoxy compounds, (film-forming) acrylate dispersions and mixtures thereof.

In one preferred embodiment, the foamable formulation of the invention comprises an epoxy resin. This can improve mechanical properties, in particular in respect of cracking, tensile strength in bending, and the haptic properties of the hardened foam. The proportion of the epoxy resin in the foamable formulation can in particular be from 0.5 to 10% by weight. A proportion that has proved particularly advantageous with respect to the required incombustibility of the hardened foam is from 1 to 5% by weight.

In another preferred embodiment, the foamable formulation of the invention comprises a water-emulsifiable epoxy compound and/or at least one self-emulsifying epoxy resin emulsion. The epoxy resin gives the hardening foamed formulation not only the advantages described above but also earlier mechanical stability, thus permitting earlier removal of the hardened geopolymer foam from the mould. When epoxy is added it is moreover possible to achieve hardening even at +5° C. The epoxy compounds can comprise a resin and hardener or a combination of resin, hardener and reactive diluent. The epoxy preferably involves a bisphenol A/F mixture and the hardener preferably involves a polyamino adduct. Reactive diluents preferably used are polyglycidic ethers of alkoxylated aliphatic alcohols.

In an embodiment to which further preference is given, an epoxy resin is mixed with a reactive diluent in a ratio of from 60:40 to 40:60 parts by weight, and with further preference from 140 to 160 parts by weight of hardener are added to this mixture. Epoxy resin used can in particular be a self-dispersing epoxy resin emulsion, and this is preferably used in a stoichiometric ratio of from 0.9:1 to 1.1:1 with a polyaminoamide adduct. Examples of commercially available self-dispersing epoxy resin emulsions that can be used are Waterpoxy® 1422, Waterpoxy® 1439, Waterpoxy® 1466 and hardener Waterpoxy® 751, Waterpoxy® 760, Waterpoxy® 801. It is preferable to use a mixture of Waterpoxy® 1422 and Waterpoxy® 760. The epoxy resin emulsions mentioned are products of BASF SE.

For hydrophobization it is possible to use additives from the group consisting of triglycerides, paraffins, polysiloxanes, hydrosilanes, alkoxysilanes, sodium methylsiliconate and mixtures thereof. Polysiloxanes are generally used in the form of silicone oils. A silicone oil with a viscosity of from 300 to 1000 mPa's can preferably be used. An example of a suitable product available commercially is AK 500 silicone oil from Wacker Chemie AG.

For dispersion it is possible to use additives from the group consisting of naphthalenesulfonate, lignosulfonate, comb polymers, such as polycarboxylate ethers, comb-shaped polyaromatic ethers, comb-shaped cationic copolymers and mixtures thereof. Dispersing agents of this type are well known in the prior art. Comb-shaped polyaromatic ethers which have particularly good suitability for increasing flowability of silicate-containing geopolymer systems are described by way of example in our WO 2013/152963 A1. Comb-shaped cationic copolymers which have particularly good suitability for increasing flowability of highly alkaline geopolymer systems are described by way of example in EP 13186438.

The fibres mentioned above can be selected from the group consisting of rock fibres (e.g. basalt fibres), glass fibres, carbon fibres, optionally modified organic fibres (PE, PP, PVA, PAN, polyesters, polyamides and the like), cellulose fibres (having a length of ≥500 μm), lignocellulose fibres, metal fibres (e.g. iron, steel and the like) and mixtures thereof. Cellulose fibers are less preferred. In particular, the compositions do not contain cellulose fibers. The proportion present of the fibres can preferably be up to 3% by weight. This can improve the mechanical stability of the hardened foam. They preferably have a length of at most 120 mm, in particular of at most 6 mm.

The fillers mentioned in the introduction can be selected from the group consisting of quartz sand or powdered quartz, calcium carbonate, rock flour, low-density fillers (for example vermiculite, perlite, diatomaceous earth, mica, talc powder, magnesium oxide, foamed glass, hollow spheres, foam sand), pigments (e.g. titanium dioxide), high-density fillers (e.g. barium sulphate), metal salts (e.g. zinc salts, calcium salts, etc.), and mixtures thereof. Grain sizes suitable here are in particular up to 1 mm. It is preferable to use foamed glass. It is particularly preferable that the average grain size of the foamed glass is from 50 to 300 μm. However, it is also possible that retarders, accelerators, complexing agents, and the like are present in the foamable formulation.

It is possible that, in the foamable formulation of the invention, all of the constituents are present together as a single component. The single-component embodiment is primarily suitable for in-situ production of finished geopolymer foam elements. Another embodiment is a dry formulation adapted for reconstituting with water (or an aqueous liquid) to form the foamable formulation. The dry formulations are often used as powder or granulate. These dry mixtures can then simply be mixed on site under addition of a defined amount of water and subsequently processed. The dry formulation embodiment is commercially viable.

“Foaming” means the introduction of gas bubbles into the foamable formulation. In various embodiments, the foam may be formed by introducing gas bubbles into the foamable formulation through mixing, beating, agitating, aerating, whipping, injecting or other mechanical actions. For such embodiments, the gas may include, but not limited to, air, nitrogen, helium, hydrogen, argon, carbon dioxide, gaseous hydrocarbons or other inert gas. Severity of mechanical actions, such as mixing time, speed and temperature, may be adjusted depending on desired foam density and the foam stability. This process can be carried out with the aid of a stator-rotor process, or of an oscillating process or by means of mechanical agitation. Alternatively, the gas phase can be introduced into the formulation via chemical processes, for example decomposition of H₂O₂ or of other peroxides or of nitrogen-containing compounds.

In one specific embodiment, the components of the foamable formulation of the invention are mixed with one another by using, for example, a commercially available mixer of the type used on construction sites. It is preferable here to form a suspension of density from 1000 to 1200 g/litre. This suspension can then be foamed in a mixing head constructed according to the stator-rotor operating principle. An example of a suitable device here is a Mugromix+model from Heitec Auerbach GmbH. A device particularly suitable for the oscillating process is marketed as “beba Schaummischer” from beba Mischtechnik GmbH.

The foamed formulation is initially fluid, so that it can be poured into moulds or otherwise formed. Thereafter, the formulation is allowed to harden by subjecting it to a temperature in the range from 0° C. to 100° C., preferably 20° C. to 80° C.

It is preferable that the wet envelope density of the foam is from 100 to 800 g/litre, in particular from 150 to 600 g/litre.

The foamed formulation is allowed to harden. In general, the foamed formulation is cured at a temperature in the range of 20 to 34° C., preferably room temperature, for at least 24 hours to obtain the geopolymer foam of the present invention. The aluminosilicates from the inorganic binder in presence of the alkaline activator undergo dissolution and polycondensation reactions to form a geopolymer network. This geopolymer network provides desired mechanical properties to the foam. If present, ordinary portland cement simultaneously reacts with the water to form calcium silicate hydrate gel due to hydration of the tricalcium silicate and dicalcium silicate present in portland cement. This hydration reaction is enhanced by the high alkalinity provided by the alkaline activator.

The process of the invention further provides that the geopolymer foam is preferably dried at temperatures of from 20 to 30° C. and at a relative humidity of least 65%. Removal from the mould can take place after from 24 to 48 hours (after as little as 12 hours when epoxy is added).

The density of the hardened geopolymer foam, dried to residual water content of about 5% by weight, is preferably (i.e. the “dry envelope density”) from 200 to 400 kg/m³, particularly preferably from 240 to 350 kg/m³ and in particular at most 300 kg/m³. The foam has very good suitability for attachment by adhesion, by use of plugs, by nails and/or by screw threads, but in another possibility it is applied in the form of foamed formulation of the invention by casting, spraying, and/or rolling, and is then allowed to harden and dry.

According to the invention, a foam is obtained with a large proportion of open cells, for example about 95% open cells and 5% closed cells. The ratio of open to closed cells can be controlled by the amount of nanocellulose. Even low amounts, for example 0.1 to 1 wt.-% of nanocellulose, result in a higher ratio of closed vs. open cells. Foams with a high amount of open cells are particularly useful as sound absorbers, whereas foams with a high amount of closed cells are particularly useful for thermal insulation.

In one preferred embodiment of the present invention, the gas phase makes up from 20 to 95 or 20 to 90 percent by volume, in particular from 50 to 90 or 50 to 60 percent by volume, of the geopolymer foam (degree of foaming; the remainder are the solids of the formulation). For acoustic effectiveness it is particularly preferable that the air content of the foam should be from 50 to 60 percent by volume.

The present invention further provides the use of the geopolymer foam of the invention for the production of an incombustible, sound-absorbing, and/or thermally insulating geopolymer foam element. The present invention further provides the use of the geopolymer foam of the invention for cavity filling to improve the sound-absorbing and/or thermally insulating properties of articles including such cavities, for example hollow bricks.

The present invention further provides an incombustible, sound-absorbing, and/or thermally insulating geopolymer foam element which comprises the geopolymer foam of the invention.

It is preferable that this geopolymer foam element of the invention is in the form of a sheet or board with a thickness from 1 cm to 20 cm, preferably from 4 cm to 8 cm, and with an edge length from 20 cm to 200 cm, preferably about 60 cm. For example, the sheet or board may have a thickness from 1 cm to 20 cm and an area of 20 cm×20 cm to 150 cm×200 cm.

The hardened geopolymer foams of the invention have inter alia the substantial advantage that they are highly flame-resistant, if not incombustible, and moreover, unlike some other foams, for example melamine resin foams, cannot liberate formaldehyde. Even when organic additives are used, and in particular in the presence of epoxy resins, very good results are achieved. No smoke or drops of flaming material are produced during flame application (DIN EN ISO 11925-2). In particular, the geopolymer foam of the invention exhibits A2 or A1 fire behaviour in accordance with DIN 13501-1.

Further, the geopolymer foam of the invention has the advantage that it can be produced easily and at low cost and, in hardened form, has good thermal insulation properties. It has surprisingly been found that the foams of the invention exhibit less micro cracks as compared to foams prepared without using nanocellulose. Moreover, the foams have an improved sound-absorbing and insulating effect. The invention allows to achieve lambda values down to about 30 mW/(m·K). Lambda values are significantly improved, for example from 80 mW/(m-K) to 40 mW/(m·K). The thermal insulation values for the geopolymer foam element of the invention are in the range from 40 to 80 mW/(m·K).

The sound absorption curve for a geopolymer foam element of the invention (according to Example 3 with a dry envelope density of 270 kg/m³ and with a thickness of 40 mm, perpendicular incidence of sound in a Kundt tube) is presented in FIG. 1. The measurements were made by the IBP institute of the Fraunhofer-Gesellschaft in accordance with DIN EN ISO 354 (2003) and, respectively, DIN EN ISO 11654 (1997). Dry envelope densities of from 240 to 350 kg/m³ are particularly suitable for sound absorption.

The compressive strength values for the geopolymer foam element of the invention depend on the composition and are from 0.1 to 1.4 MPa after 7 days of hardening at from 23 to 25° C. and 65% rel. humidity, where the test samples are foil-covered until they are removed from the mould, and where, in accordance with the object stated in the introduction, preference is naturally given to the higher values. This is in agreement with μ-CT investigations (micro-computer tomography). A defect analysis using μ-CT has shown that a foam prepared without using nanocellulose includes more than 70% of airholes, whereas a foam prepared with nanocellulose includes less than 70% of airholes. The presence of airholes impairs the mechanical stability of the foam. For example, a foam prepared without nanocellulose resulted in a material with 76% of airholes which impair the mechanical stability. By contrast, a foam prepared using 1 wt.-%, 3 wt.-% of cellulose nanocrystals or 3 wt.-% cellulose nanofibrils include only 66%, 51% or 57% of airholes, respectively.

It is moreover also possible to provide cladding to the geopolymer foam element sheet of the invention, but care must be taken here to ensure that there is no substantial resultant impairment of the sound-absorbing properties of the element. Particularly suitable materials here are non-woven wool fabric, rendering materials, paint and textiles with an open-pore structure permeable to sound. In particular, the textiles can have a coloured or printed pattern.

The non-limiting examples and the attached FIGURE below will now provide further explanation of the present invention. In the drawings:

### EXAMPLES

### Example 1: Production of a Geopolymer Foam from Metakaolin

The components listed in Table I were mixed using a manual mixer.

TABLE 1

| | | Description, trade name | Mass | |
|---|---|---|---|---|
| | Component | (producer) | (g) | Wt.-% |
| (1) | Potassium | K 45 M (Woellner GmbH | 216.08 | 36.8 |
| | water glass | & Co. KG), 40 wt % aqueous | | |
| | | solution | | |
| (2) | Surfactant | C₈₋₁₀-alkyl polyglucosid | 3.44 | 0.6 |
| | | (m = 1-5), Glucopon ® | | |
| | | DK225 (BASF SE), 68-72 | | |
| | | wt % aqueous solution | | |
| (3) | Metakaolinite | Metamax ® (BASF SE) | 123.44 | 21.0 |
| (4) | Hollow | Fillite ® 106 hollow | 115.44 | 19.6 |
| | spheres | aluminosilicate beads | | |
| | | (Omya GmbH) | | |
| (5) | Cellulose | Cellulose nanocrystals, | 5.84 | 1 |
| | nanocrystals | spray-dried (The University | | |
| | | of Maine, Process | | |
| | | Development Center) | | |
| (6) | Water | | 123.44 | 21.0 |
| | (additionally | | | |
| | added) | | | |
| Total | | | | 100 |

The components were mixed and finally foamed to a volume of about 6 dm³. The air content of the foam was approx. 90 vol.-%. The air content was determined by way of the volume change in comparison with the unfoamed suspension by a method based on DIN EN 1015-6.

The foam was formed into a prisma of 16×4×4 cm and hardened for 24 h at a temperature of 25° C. and a relative humidity of 100%, and afterwards at 25° C., 65% relative humidity for 6 days, the prisma was then subjected to a pressure and bending test in accordance with DIN EN 196-1. The results are shown in table 2 below.

### Example 2

Example 1 was repeated using 1 wt.-% by solid of an aqueous slurry of nanocellulose (11.8 wt % CNC content) and 1 wt.-% by solid of an aqueous slurry of cellulose nanofibrils (NFC, 3.4 wt % NFC content) in the formulation. The results of the pressure and bending test are also shown in table 2.

TABLE 2

| | | Exam- | Exam- | Exam- | Exam- |
|---|---|---|---|---|---|
| | Refer- | ple 1 | ple 2 | ple 2 | ple 2 |
| | ence | 1 wt % | 3 wt % | 1 wt % | 1 wt % |
| | no | CNC | CNC | CNC | NFC |
| | CNC | SD* | SD* | slurry | slurry |
| Density (g/L) | 109 | 176 | 177 | 170 | 155 |
| Tensile bending | 14 | — | 25 | 30 | 22 |
| strength (MPa) | 12 | — | 51 | 28 | 23 |
| | 15 | — | 53 | 30 | 23 |
| Compressive | 114 | 124 | 111 | 121 | 122 |
| strength (MPa) | 98 | 100 | 119 | 120 | 111 |
| | 103 | — | 112 | 120 | 124 |

*SD: spray-dried

As can be seen, the mechanical properties of a foam prepared by using CNC or NFC are significantly improved as compared to a foam without nanocellulose.

1. A method for producing a geopolymer foam, comprising
(i) providing a foamable formulation comprising:
a) at least one inorganic binder selected from the group consisting of latently hydraulic binders, pozzolanic binders and mixtures thereof;
b) at least one alkaline activator selected from the group consisting of alkali metal hydroxides, alkali metal carbonates, alkali metal aluminates, alkali metal silicates and mixtures thereof;
c) at least one surfactant selected from the group consisting of anionic surfactants, cationic surfactants, non-ionic surfactants and mixtures thereof,
d) 0.1 to 5 wt.-%, based on the weight of the formulation, of nanocellulose, and
e) water,
(ii) foaming the formulation; and
(iii) allowing the foamed formulation to harden.

2. The method according to claim 1, wherein the inorganic binder is selected from the group consisting of blast furnace slag, microsilica, metakaolin, aluminosilicates, fly ash and mixtures thereof.

3. The method according to claim 2, wherein the inorganic binder comprises metakaolin.

4. The method according to claim 1, wherein the alkaline activator is selected from alkali metal hydroxides of the formula MOH and alkali metal silicates of the formula m SiO₂.nM₂O, where M is the alkali metal, and the molar ratio m:n is ≤4.0.

5. The method according to claim 4, wherein the alkaline activator comprises a mixture of alkali metal hydroxides and of alkali metal silicates.

6. The method according to claim 1, wherein the surfactant is a non-ionic surfactant, optionally an alkyl polyglucoside.

7. The method according to claim 6, wherein the alkyl polyglucoside has the formula H—(C₆H₁₀O₅)ₘ—O—R¹, where (C₆H₁₀O₅) is a glucose unit and R¹ is a C₈₋₁₂-alkyl group, and m=from 1 to 5.

8. The method according to claim 1, wherein the nanocellulose is selected from cellulose nanocrystals, cellulose nanofibrils, and tunicate cellulose nanocrystals.

9. The method according to claim 8, wherein the nanocellulose is cellulose nanocrystals.

10. The method according to claim 1, wherein the nanocellulose has a length in the range from 25 to 4000 nm.

11. The method according to claim 1, wherein the nanocellulose has a width in the range from 2 to 70 nm.

12. The method according to claim 1, wherein the nanocellulose has a crystallinity of 40 to 90%.

13. A geopolymer foam obtained by the method according to claim 1.

14. A geopolymer foam comprising regions of a gas separated by a solid film of a geopolymer, the geopolymer having nanocellulose dispersed therein.

15. A foamable formulation for the manufacture of a geopolymer foam comprising:
a) at least one inorganic binder selected from the group consisting of latently hydraulic binders, pozzolanic binders and mixtures thereof;
b) at least one alkaline activator selected from the group consisting of alkali metal hydroxides, alkali metal carbonates, alkali metal aluminates, alkali metal silicates and mixtures thereof;
c) at least one surfactant selected from the group consisting of anionic surfactants, cationic surfactants, non-ionic surfactants and mixtures thereof;
d) 0.1 to 5 wt.-%, based on the weight of the formulation, of nanocellulose, and
e) water.

16. A dry formulation adapted for reconstituting with water to form a foamable formulation according to claim 15.

17. A geopolymer foam element comprising the foamable formulation according to claim 15 which is flame-resistant, sound-absorbing, and thermally insulating.

18. A geopolymer foam element comprising the geopolymer foam of claim 13 which is flame-resistant, sound-absorbing, and thermally insulating.

19. The geopolymer foam element according to claim 18 in the form of a sheet or board.

20. The foamable formulation according to claim 15 in the form of cavity filling.

21. A geopolymer foam element comprising the geopolymer foam of claim 14 which is flame-resistant, sound-absorbing, and thermally insulating.
